(19) United States
(12) Patent Application Publication
(10) Pub. No.: US 2026/0159750 A1
(43) Pub. Date: Jun. 11, 2026

(54) APPLICATION OF CO FOR RECOVERY OF HEAVY AND ULTRA HEAVY OILS

(71) Applicant: Paul B. Trost, Golden, CO (US)

(72) Inventor: Paul B. Trost, Golden, CO (US)

(21) Appl. No.: 19/537,940

(22) Filed: Feb. 12, 2026

Related U.S. Application Data
(63) Continuation-in-part of application No. 19/322,583, filed on Sep. 8, 2025.
(60) Provisional application No. 63/691,952, filed on Sep. 6, 2024.

(51) Int. Cl. C09K 8/594

(52) U.S. Cl. CPC C09K 8/594; C09K 2208/10

(57) ABSTRACT

Methods for increasing and improving the recovery of heavy and ultra heavy oils by using carbon monoxide (CO). The methods include injecting a CO-containing gas stream, which may include CO2, into an oil reservoir to facilitate removal of heavy and ultra heavy oils from the reservoir. The CO-containing gas stream may be injected into an oil reservoir with steam; the amount of steam used is less than if no CO-containing gas stream were injected. The methods also include bubbling a CO-containing gas stream through vessels used in tar sands extraction. The methods also include injecting CO and CO2 in abandoned non economic SAGD wells to economically rejuvenate the wells.

### CROSS REFERENCE

This application is a continuation-in-part of U.S. application Ser. No. 19/322,583 filed Sep. 8, 2025 and titled APPLICATION OF CO FOR RECOVERY OF HEAVY AND ULTRA HEAVY OILS, which claims priority to U.S. provisional application No. 63/691,952 filed Sep. 6, 2024 and titled APPLICATION OF CO AND OPTIONALLY CO2 FOR RECOVERY OF HEAVY AND ULTRA HEAVY OILS AT RESERVOIR TEMPERATURES UP TO 350F, the entire disclosures of which are incorporated herein for all purposes.

### BACKGROUND

Recovery of ultra heavy and heavy crude oils, having API gravities of <10-20° API, is very difficult to achieve economically and environmentally. Asphaltene, a molecule found in these oils, is a major source of these difficulties. Asphaltene molecules typically are surrounded by other asphaltenes, kerogens and long chain hydrocarbons. This association inhibits the recovery of the ultra heavy and heavy crude oils due to the large combined molecular size (the size of the asphaltene plus the long chain hydrocarbons); the large size inhibits their transit through the small pore throats in the reservoir rock. As the API gravity decreases (i.e., as the oil gets more “heavy”), the concentration of the asphaltene rapidly increases.

In addition to these problems, when combined with water - especially hot water such as steam-the asphaltenes tend to form emulsions with the water. Emulsions are a mixture of two immiscible phases that under certain conditions can be mixed together and difficult to separate. These emulsions are often created during oil recovery operations due to the energy (e.g., shear forces) impacting the oil and water in the well bore and the energy added by pumping the oil; in some instances, the recovery process is designed to produce emulsions in order to aid heavy oil recovery factors. However, once the heavy oil emulsions are produced they are difficult and expensive to break. These emulsions, both those formed during the crude oil production phase and during subsequent processing phases, must be broken in order to recover the entrained oil.

Extraction of asphaltene-rich crude oil is typically done by heating the heavy oil-containing reservoirs with large quantities of steam. When the heavy oil is extracted, it is a mixture of an asphaltene-containing emulsion and water. Most production from drilled heavy oil wells includes emulsions that may be 70+% water, 10+% sand and clays, and only 10-20% heavy crude oil.

In open pit surface mining of oil sands (aka, tar sands), emulsions are specifically created in an attempt to facilitate the separation of the oil, as an emulsion, from the sand.

However, whether the emulsion is a by-product or a desired step, the emulsified oil needs to be extracted and separated from the water, sand and clays in the emulsion. To achieve breaking of the emulsions and recover the entrained heavy oil, chemical agents such as solvents, de-emulsifiers, and either paraffinic compounds or aromatic compounds, are used. Use of these agents requires numerous surface mechanical pieces of equipment such as pumps, vats, skimmers, centrifuges, and tanks, in addition to the chemical agents. Breaking of the emulsions to liberate the entrained oil and separate the associated sand and clays is costly and time consuming.

However, without the steam heating of the reservoirs that results in the emulsions, the recovery factor of heavy oils may be only 2-10% of the oil in place. Thus, some process needs to be done to extract the heavy oil, and steam heating is currently the most used process.

Many research efforts are underway to minimize or negate steam usage. Solvents, such as light hydrocarbons (e.g., propane, butane, pentane) or solvent-type chemicals, and often carbon dioxide (CO2), are injected into the heavy oil reservoirs to minimize the emulsion problems and enhance heavy oil production. To date, these processes have not been feasible on a large scale.

In addition to the above issues in extracting the oil from the emulsions, numerous environmental problems are created by the production of heavy and ultra heavy oils. These problems include generation and emission of large quantities of CO2, significant volumes of water and natural gas (as a heat source) are required to make steam, some operations leave major surficial disturbance (e.g., open pit surface mining), and the presence of tailings ponds.

Therefore, what is needed is a process to minimize steam-related production, to minimize the in situ emulsion production, and/or improve the separation of the oil from the emulsion. More preferably would be the recovery of the heavy oil at existing reservoir temperature and pressures without the need for steam and the associated emulsion formation. A heavy oil recovery process under low temperatures (e.g., <350° F.) and low pressures (e.g., <900 psi) would be both economically and environmentally beneficial.

### SUMMARY

The present disclosure is directed to methods for increasing and improving the recovery of heavy and ultra heavy oils by using carbon monoxide (CO). The method includes injecting a CO-containing gas stream, which may include CO2, into an oil reservoir to facilitate removal of heavy and ultra heavy oils from the reservoir, at natural reservoir temperatures (less than 350° F.) and pressures (e.g., less than 900 psi) and/or at slightly elevated temperatures. In some methods, surfactant is present in the CO-containing gas stream and additionally or alternately, nanoparticles are present in the CO-containing gas stream. The CO-containing gas stream may be injected into an oil reservoir in conjunction with steam to facilitate removal of heavy and ultra heavy oils from the reservoir. The amount of steam used is thus less than if no CO-containing gas stream were injected.

The presence of carbon monoxide, or carbon monoxide mixed with carbon dioxide, when injected into the reservoir, can achieve heavy oil (16-20° API) extraction; for ultra heavy oil extraction, some steam may be required. When steam is used, the reservoir temperature is no greater than 350° F. The oil recovery is achieved with little or no formation of emulsions, even though steam is used. Injection of carbon monoxide, or a mixture of carbon monoxide and carbon dioxide, into an existing Steam Assisted Gravity Drainage (SAGD) operation aids oil recovery and minimizes emulsion formation. A reduction of both viscosity and API gravity of the produced oil occurs due to the presence of the carbon monoxide and carbon dioxide. This may also result in the shrinking of swelling clays caused by the steam, thus providing access to bypassed portions of the reservoir.

Injecting a CO-containing gas stream, particularly one with a mixture of carbon monoxide and carbon dioxide, at temperatures lower than typical steam (SAGD) recovery, e.g., less than 350° F., lowers operating costs and minimize CO2 emissions compared to SAGD recovery without a CO-containing gas stream.

Additionally, injection of a CO-containing gas stream, particularly one with a mixture of carbon monoxide and carbon dioxide, into old, shut-in SAGD wells can recover additional oil by utilizing the already hot reservoir conditions from past SAGD operations. In such a manner, rejuvenation of old SAGD wells can be achieved at minimal costs. Reopening an old well also avoids plugging costs.

The amount of carbon monoxide in the CO-containing gas stream is adjusted to optimize the recovery factor for each individual oil deposit based on the amount of asphaltenes present in the oil. Typically, higher concentrations of CO concentrations are required as API gravity decreases. For example, a 16° API oil could use a CO/CO2 gas stream of 25-35% CO and 65-75% CO2. Alternately, a 10° API ultra heavy crude oil may require up to 50% CO and 50% CO2. Similarly, the ratio of carbon monoxide and carbon dioxide, if present, is adjusted to optimize the recovery factor for each individual oil deposit based on the amount of asphaltenes present in the oil. It is important to note, a concentration of CO less than about 6% of the gas stream is typically not very efficacious for enhancing oil recovery.

When CO, or CO mixed with CO2, is used with steam, the presence of the CO inhibits and preferably eliminates emulsion formation; the presence of the CO also minimizes entraining sand and clay with the oil. Additionally, the presence of the CO shrinks swelling clays caused by the steam injection, thus allowing additional oil recovery.

The CO-containing gas stream aids in heavy oil recovery by inhibiting emulsion formation with oil in in situ steam recovery methods. The presence of CO alone, or CO mixed with CO2, or mixed with other emulsion breaking chemicals, aids in the breaking of any produced emulsions and shrinking swelling clays.

The breaking of emulsions and/or inhibiting of emulsion formation is a two fold process: the CO reduces and separates clumps of asphaltene molecules, resulting in lower viscosities, and the sigma bond of the CO minimizes the attraction between the two (oil/water) immiscible phases.

The presence of additives such as surfactants and nanoparticles may increase the oil recovery, e.g., achieving a 5-10% increase, due to the combined effects of both the CO in the CO-containing as stream and the surfactants and/or nanoparticles.

Use of the CO also provides environmental benefits and lowers operating costs. Using a CO-containing gas stream minimizes the amount of steam needed, thus reducing the energy used to form the steam, and also reducing the temperature of the reservoir by not needing additional heating techniques. Use of the CO also decreases the volume of carbon dioxide emitted into the atmosphere (e.g., by reducing the need for steam production). After recovering the heavy oil from the reservoir, the injected CO and any CO2 can be removed and sequestered, or minor amounts of the CO and CO2 can be recovered and recycled for ultimate sequestration, thus providing an additional environmental benefit.

One particular embodiment provided herein is a method for heavy and ultra heavy oil extraction from an oil reservoir, the method including injecting into the oil reservoir a CO-containing gas stream comprising at least 25% by volume CO, at reservoir temperature and pressure. Reservoir temperature is typically less than 350° F.

Another particular embodiment provided herein is a method of heavy and ultra heavy oil extraction from an oil reservoir, the method including injecting into the oil reservoir steam and a CO-containing gas stream comprising at least 25% by volume CO.

The CO-containing gas stream may have at least 25% by volume or at least 50% by volume CO, and may also comprise CO2. In some embodiments, the gas stream has only CO and CO2. The CO-containing gas stream may have up to 1% surfactant, and/or up to 5% nanoparticles. The amount of CO in the gas stream can be adjusted based on an amount of asphaltenes in the oil; the amount of CO is increased as the amount of asphaltenes increases. The amount of CO can also be adjusted based on the amount of additives such as surfactant and nanoparticles.

The CO-containing gas stream and steam can be injected as independent streams, simultaneously or sequentially, or the two streams can be combined and injected.

Another particular embodiment provided herein is a method of heavy and ultra heavy oil production from tar sands, the method including bubbling a CO-containing gas stream through emulsified heavy and ultra heavy oil retained in a vessel or reservoir.

These and other aspects of the technology described herein will be apparent after consideration of the Detailed Description herein. It is to be understood, however, that the scope of the claimed subject matter shall be determined by the claims as issued and not by whether given subject matter addresses any or all issues noted in the Background or includes any features or aspects recited in the Summary.

### DETAILED DESCRIPTION

As indicated above, described herein are methods of increasing and improving heavy and ultra heavy oil recovery by the use of gaseous CO that is injected into the reservoir as a CO-containing gas stream.

Carbon monoxide (CO) has been shown by Trost (see, e.g., U.S. Pat. Nos. 9,951,594B2 , 10,316,631B2 , and 10,876,384B2 , each of which is incorporated herein by reference in its entirety) to aid in oil recovery and provide other benefits when injected into the oil producing reservoir. For instance, (1) CO has the capability of lowering the IFT by acting as a surfactant, (2) CO, a reducing agent, is capable of reacting with ferric iron in swelling clays to shrink the clays and thus increase pore throat diameters, (3) CO can alter oil wet reservoirs to water wet reservoirs due to its polarity and capability of displacing adsorbed hydrocarbons on reservoir mineral surfaces, (4) CO achieves swelling of the oil thus decreasing the viscosity of the oil, (5) CO adsorbs onto asphaltenes thereby partially liberating the associated long chain paraffins, resins, and other heavy oil molecules, (6) CO inhibits corrosion of oilfield tubulars, (7) CO has some solubility in crude oil and thus CO, by itself aids heavy oil and ultra-heavy oil recovery, and being a small molecule, has been shown to aid in the faster recovery of the oil and to access lower permeability areas of the reservoir that have higher residual oil saturation, and (8) the presence of CO allows oil recovery at lower pressures thereby providing an economic advantage. These qualities and benefits are due to the introduction of CO into the reservoir. Also in these patents, Trost has shown that CO-by itself-is capable of recovering crude oil having 20-42° API gravities.

Use of CO on heavy oils, which have an API gravity between about 10° and about 16°, and/or ultra heavy oils, which have an API gravity less than about 10°, provides a significant advantage to both SAGD and tar sand methods of heavy oil recovery.

As indicated above, the present discussion is directed to methods for increasing and improving the recovery of heavy and ultra heavy oils by injecting a CO-containing gas stream, which may include CO2, into an oil reservoir to facilitate removal of heavy and ultra heavy oils from the reservoir, at natural reservoir temperatures (less than 350° F.) and natural reservoir pressures (e.g., less than 900 psi). The CO-containing gas stream may be injected into an oil reservoir with steam to facilitate removal of heavy and ultra heavy oils from the reservoir. The CO-containing gas stream includes at least 20% (by volume) CO, often at least 25%, 35%, or 50%. In embodiments where both CO and CO2 are present, they form at least 40% or at least 50% of the total CO-containing gas stream. Additives such as surfactant and/or nanoparticles may be present in the gas stream. In some embodiments, the CO-containing gas stream includes only CO and CO2, whereas in other embodiments additional gases may be present, typically at a level of no more than 50%, usually no more than 25%. In some embodiments, the CO and CO2 are simultaneously injected from independent streams, at the desired ratio or volume percentage. Additional details regarding the CO-containing gas stream are provided below.

The CO acts on, and affects, the heavy and ultra heavy oils in various ways.

Geochemically, carbon monoxide is a triple bonded molecule (e.g., having one double bond and another single pair of electrons forming a sigma bond). This type of bonding allows the CO molecule to bond with certain elements such as iron, nickel, cobalt, and vanadium to form carbonyls such as Fe(CO)5. The asphaltene molecule, found in ultra heavy and heavy oils, usually contains iron, cobalt, nickel, and/or vanadium. Thus, the CO is strongly attracted to these metals to form carbonyls or “pseudo-carbonyls” on the exterior or interior of the asphaltene molecules. Formation of these “pseudo-carbonyls” displaces the associated asphaltene, kerogens and long chain paraffins molecules from the targeted asphaltene molecule, thereby decreasing the physical size (cross-sectional area) of the asphaltene, thus aiding movement, e.g., through the pore throats, and thereby increasing recovery of the heavy oil.

Additionally, the presence of these carbonyls or “pseudo-carbonyls” inhibits the formation of emulsions. In laboratory slim tube studies, formation water containing CO/CO2 was injected into heavy oil-containing slim tubes at room temperature and pressure (which are less than natural reservoir temperature and pressure). The result was emulsion-free oil. A high recovery factor, 81-85% of the original oil, was achieved in these slim tube studies.

Based upon this slim tube research with heavy oils, the discovery of economic and environmental benefits of CO alone, or CO mixed with CO2, is an excellent new approach to achieve heavy, and ultra heavy oil, recovery at reservoir temperatures lower than 350° F., such as when a lower grade steam is used and possibly lower pressures.

In addition to the CO/CO2 in the slim tube testing having not formed noticeable emulsions, the presence of CO, or CO mixed with CO2, may inhibit or aid in the breaking of emulsions, both in situ (e.g., downhole) during Steam Assisted Gravity Drainage (SAGD) and during surficial emulsion processing. The CO reduces and separates clumps of asphaltene molecules, resulting in lower viscosities, and the sigma bond of the CO minimizes the attraction between those asphaltene molecules and water. Addition of a surfactant with the CO further can reduce the viscosity, decrease emulsions, and further reduce and separate the clumps.

SAGD is an oil recovery technique where steam is injected into horizontal and parallel wells drilled in the oil reservoir, one several feet above the other. The steam is injected into the upper well to heat the surrounding oil and reduce its viscosity, causing the heated oil and steam condensate to drain into the lower well due to gravity, where it is pumped out. Addition of the CO/CO2 with the steam is preferable, but may also be conducted as slugs of steam followed by a slug of CO, CO/CO2, or CO2.

The CO-containing gas, optionally having CO2, is injected into the upper well with the steam to improve the recovery of oil as compared to using just steam. The CO-containing gas can be injected as a stream concurrently with the steam or prior to injecting the steam down hole, the two streams being injected independently. The CO-containing gas stream may be injected at the same pressure as the steam or at a higher or lower pressure. The volume of the gas stream may be the same as, less than, or greater than the volume of the steam injection. Alternately, the CO-containing gas can be combined with the steam prior to injection.

Not only does the CO/CO2 in the CO-containing gas reduce the physical size of the asphaltenes in the oil allowing easier passage through the pore throats, minimize emulsion formation in situ within the heavy oil as shown by the slim tube tests, and facilitate the surficial treating of emulsion to free the oil, the CO/CO2 from the CO-containing gas reduces the swelling clays in the reservoir, the swelling occurring due to the exposure of the clays to steam.

Heavy oil deposits typically are associated with iron-bearing clayey sandstones, with the clay being montmorillonite, illite, smectite, chlorite and/or glauconite, all of which have significant iron hydroxides content. As the steam encounters these clays, the clays absorb an amount of the steam, thus physically swelling the clays. Swelled or swelling clays greatly reduce the reservoir permeability by decreasing the pore throats. This action significantly inhibits heavy oil recovery factors. The presence of CO and optionally CO2 reduces these swelling clays, thus reducing the loss of permeability and the corresponding loss of production of oil.

The amount of CO and any CO2 in the CO-containing gas stream for SAGD can be adjusted based on the API of the oil (usually 6°-10° for ultra heavy and 10°-22° for heavy), the chemical composition of the oil (e.g., the amount of asphaltenes), and also the chemical and physical make-up of the reservoir.

The CO-containing gas stream is at least 20% by volume CO, usually at least 35% by volume CO, and in some embodiments at least 50% by volume CO or at least 70% by volume CO, in some embodiments the remainder being CO2. In some embodiments, the gas stream is 100% CO. However, in some embodiments, the amount of CO may be no more than 65% by volume. Minor impurities such as N2, H2, may be present in the CO/CO2 gas stream, these total impurities being no more than 1%. Particular examples of CO-containing gas streams include 20:85 CO:CO2, 25:75 CO:CO2, 35:65 CO:CO2, 50:50 CO:CO2, 65:35 CO:CO2, and 70:30 CO:CO2. Typically, the higher the amount of asphaltenes, the higher the amount of CO. Depending on the chemical composition of the oil and/or the reservoir, other gases such as N2, H2, or light hydrocarbons (e.g., methane, ethane, etc.) may be included in the gas stream, usually at no more than 50% of the CO-containing gas stream.

Utilizing a CO-containing gas stream, especially a CO/CO2 gas stream, with SAGD provides both technical and economic benefits to the heavy oil recovery—emulsions are not formed, or at least minimized, and the overall recovery of the oil is higher than when only steam is used.

A CO-containing gas can also be added to mining of oil sands to achieve technical and economic benefits. Mining of oil sands is accomplished by washing the mined oil sands with either very hot water or steam to form an emulsion and ultimately separate the water, oil, sand and clays. These separating processes occur in covered surface vessels, such as tanks or pits. The addition of CO-containing gas, either CO or CO/CO2, bubbled through the emulsion contained within the vessels, achieves a faster and more economical oil recovery for tar sands processes, due to breaking the kerogens and other long chain hydrocarbons away from the asphaltene. The vessels may additionally include known emulsion breakers.

In oil sands, the emulsion is already formed prior to contact with the CO-containing gas; the CO/CO2 facilitates the oil recovery by breaking the emulsion.

As above for SAGD, the amount of CO and any CO2 in the CO-containing gas stream can be adjusted based on the API of the oil (usually 6°-10° for ultra heavy and 10°-20° for heavy), the chemical composition of the oil (e.g., the amount of asphaltenes), and also the chemical make-up of the contents in the vessels (e.g., solvents, emulsion breakers, etc.).

For bubbling, the gas (CO-containing) stream is at least 20% by volume CO, usually at least 35% by volume CO, and in some embodiments at least 50%, 70% or 75% by volume CO. In some embodiments, the gas stream is 100% CO. The remainder of the gas stream is CO2. Minor impurities such as N2, H2, may be present in the gas stream. Particular examples of gas streams include 50:50 CO:CO2, 65:35 CO:CO2, 70:30 CO:CO2, 75:25 CO:CO2 and 80:20 CO:CO2. Typically, the higher amount of asphaltenes, the higher the amount of CO. Depending on the chemical composition of the emulsion, other gases such as N2, H2, or light hydrocarbons (e.g., methane, ethane, etc.), usually no more than 25% may be included in the gas stream with the CO/CO2.

The volume and pressure of the bubbled gas stream is sufficiently high to break through the hydrostatic tank pressure. The CO-containing gas stream may be bubbled from or proximate to the bottom of the tank or may be injected through the sides of the vessel. In both scenarios, the gas stream rises through the emulsified material in the vessel so that the CO/CO2 contacts the asphaltenes. Agitation may be present within the vessel to better distribute the bubbles throughout the vessel.

As with SAGD, utilizing a CO-containing gas stream, especially a CO/CO2 gas stream, with oil sands provides both technical and economic benefits to the heavy oil recovery—the overall recovery of the oil is higher when the CO and optionally CO2 is bubbled therethrough.

In any of the methods, e.g., injection into a reservoir, SAGD, oil sands, or any bubbling, the CO-containing gas (optionally including CO2) can include other additives, depending on the reservoir conditions.

The CO-containing gas stream can include an acidic component, e.g., an added acid such as sulfuric or hydrochloric acid. For heavy oil adsorbed onto limestone reservoir rock, the addition of acid achieves etching of the limestone face and subsequent liberation of additional heavy oil, thereby making the attraction of the CO to the heavy oil more readily available and further aiding the recovery factor.

A surfactant(s) may be included in the CO-containing gas stream, to improve the interaction with heavy oils, including with saturated aromatics, resins, and asphaltenes (referred to as SARA materials or molecules). The surfactant improves the recovery of heavy oils via three possible mechanisms: (1) improves attraction to the surface of the SARA molecules functional groups, (2) improves adsorption onto the reservoir mineral grain surfaces to liberate the adsorbed SARA molecules, and (3) provides a link to the functional groups of the SARA molecules and to water, thereby facilitating pulling of the SARA molecules, all thereby aiding heavy and ultraheavy oil recovery. These three actions complement the interaction between CO and the iron, cobalt, nickel and/or vanadium present in the asphaltenes present in the heavy and ultra heavy oils. In some methods when surfactant is present, the amount of CO in the CO-containing gas stream is about 25% to 50% and the surfactant is less than about 1%. For tar sands, particularly if the CO in the gas stream is 50% or more, the surfactant is up to about 2%.

For many applications, the salinity of the environment is a significant, potentially major limiting factor for surfactant-aided recovery. Very high salt content (typically >60,000 TDS) tends to compete to block surfactant access to the functional groups of the SARA molecules. However, the CO in the CO-containing gas stream is minimally affected by salinity, as CO forms a very strong bond with the SARA-type molecules via attraction to the asphaltenes'functional groups and also to the iron, cobalt, nickel and/or vanadium present in the asphaltenes.

Thus, the addition of surfactant to the CO-containing gas stream further enhances the recovery of heavy and ultra heavy oils. Experimental data has shown high recovery factors of heavy oil at reservoir temperature and pressures of 84-86% using CO/CO2 without the presence of surfactants. However, the addition of surfactants to the CO/CO2 further increases the recovery factor, estimated to be about 2%-10%.

In addition or alternatively, nanoparticles can be included in the CO-containing gas stream, to improve the recovery of heavy oils. Examples of nanoparticles include those made from Al₂O3 (alumina or aluminum oxide), SiO2 (silica), NiO (nickel oxide), TiO2 (titanium dioxide), ZrO2 (zirconia), ZnO (zinc oxide) and multimetallic materials. The nanoparticles typically are 1-100 nm in largest dimension, as this size is readily mobile through porous reservoir rock and avoids pore plugging, in some embodiments, allowing for a better mobility ratio, e.g., movement of the viscous heavy oil through less viscous water. Nanoparticles are stable under conditions that typically result in high TDS (total dissolved solids).

The nanoparticles may act as a surfactant, reducing IFT between the heavy oil and water, e.g., steam. In some embodiments, the nanoparticles facilitate formation of foams or emulsions; however, with the CO, the foams and emulsions are reduced or eliminated/destroyed, improving oil recovery. Nanoparticles have the capability of forming a stronger bond to the reservoir mineral (rock) surface than the oil, thus liberating the heavy oil and further facilitating a higher recovery factor.

Nanoparticles are stable under formation water conditions that typically result in high TDS (total dissolved solids). However, the presence of higher TDS (e.g., TDS >70-80,000) in the formation water tends to cause precipitation of the nanoparticles, thus limiting their effectiveness; however, nanoparticles do have a higher tolerance to high TDS formation water than do most surfactants. As indicated above, the effectiveness of CO on oil recovery is not inhibited by higher TDS, due to the attraction of CO to the iron, cobalt, nickel and/or vanadium present in the oil. Thus, the combination of nanoparticles with the CO-containing gas stream further enhances the recovery of heavy and ultra heavy oils.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Various features and details have been provided in the multiple designs described above. It is to be understood that any features or details of one design may be utilized for any other design, unless contrary to the construction or configuration. Any variations may be made.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

From the foregoing description and examples, it will be appreciated that specific embodiments of the invention have been described herein for purposes of illustration, but that various modifications may be made without deviating from the scope of the invention. Accordingly, the invention is not limited except as by the appended claims.

What is claimed:

1. A method of heavy and ultra heavy oil extraction from an oil reservoir, comprising:
injecting into the oil reservoir steam and a CO-containing gas stream comprising at least 25% by volume CO.

2. The method of claim 1, wherein the injecting is at reservoir temperature and pressure.

3. The method of claim 2, wherein the gas stream comprises at least 35% by volume CO and CO2.

4. The method of claim 3, wherein the gas stream consists of CO and CO2.

5. The method of claim 1, wherein the gas stream comprises surfactant and 25% to 50% by volume CO.

6. The method of claim 1, wherein the gas stream comprises nanoparticles.

7. The method of claim 1, wherein the gas stream and steam are injected as independent streams.

8. The method of claim 7, wherein the gas stream and steam are injected simultaneously.

9. The method of claim 1, wherein the gas stream is combined with the steam and injected.

10. The method of claim 1, wherein an amount of CO in the gas stream is based on an amount of asphaltenes in the oil.

11. The method of claim 10, wherein the amount of CO is increased as the amount of asphaltenes increases.

12. The method of claim 1, comprising:
injecting into an old well steam and the CO-containing gas stream comprising CO and CO2 to shrink swelling clays and to recover additional oil.

13. A method of heavy and ultra heavy oil extraction from an oil reservoir, comprising:
injecting into the oil reservoir a CO-containing gas stream comprising at least 35% by volume CO and CO2, wherein the CO is at least 25%,
with no injection of steam into the reservoir.

14. The method of claim 13, wherein the gas stream consists of CO and CO2.

15. The method of claim 13, wherein an amount of CO in the gas stream is based on an amount of asphaltenes in the oil.

16. The method of claim 15, wherein the amount of CO is increased as the amount of asphaltenes increases.

17. A method of extracting heavy and ultra heavy tar sands oil from an emulsion in a vessel, comprising:
bubbling into the emulsion in the vessel a CO-containing gas stream comprising at least 50% by volume CO.

18. The method of claim 17, wherein the gas stream consists of CO and CO2.

19. The method of claim 17, wherein the emulsion includes emulsion breakers.

20. The method of claim 17, wherein the gas stream comprises surfactant.
